(19) United States
(12) Patent Application Publication
(10) Pub. No.: US 2025/0360673 A1
(43) Pub. Date: Nov. 27, 2025

(54) BINDER JETTING OF STRONG GREEN PARTS WITH A CROSSLINKER

(71) Applicant: Chao MA, Gilbert, AZ (US)

(72) Inventor: Chao MA, Gilbert, AZ (US)

(73) Assignee: Arizona Board of Regents on Behalf of Arizona State University, Scottsdale, AZ (US)

(21) Appl. No.: 19/219,937

(22) Filed: May 27, 2025

Related U.S. Application Data
(60) Provisional application No. 63/651,864, filed on May 24, 2024.

(51) Int. Cl. B29C 64/165; B29C 64/209; B29K 286/00; B29K 309/00; B33Y 10/00; B33Y 40/20; B33Y 80/00

(52) U.S. Cl. CPC B29C 64/165; B29C 64/209; B33Y 10/00; B33Y 40/20; B33Y 80/00; B29K 2286/00; B29K 2309/00

(57) ABSTRACT

A method is disclosed for binder jetting of strong green parts using a crosslinker to form covalent bonds among binder molecules. In the disclosed process, a powder and a binder are prepared, and a crosslinker is introduced either by premixing with the binder or powder, or by in-situ deposition through a printhead. During the printing process, the binder and crosslinker are selectively jetted into the powder bed to form green parts layer by layer. The green parts are subsequently cured to induce crosslinking and solvent removal, resulting in chemically bonded binder networks. This method enables the fabrication of mechanically robust green parts without requiring high-temperature sintering, thereby allowing use with heat-sensitive materials. The approach is applicable to a wide range of binders, powders, and crosslinkers, and is particularly suited for manufacturing sorbent structures for carbon capture, water treatment, and catalytic applications.

### RELATED APPLICATIONS

This application claims the benefit of U.S. provisional patent application 63/651,864, filed May 24, 2024 to Chao Ma, titled “BINDER JETTING OF STRONG GREEN PARTS WITH A CROSSLINKER,” the entirety of the disclosure of which is hereby incorporated by this reference.

### TECHNICAL FIELD

This document relates to a method for fabricating a green part through binder jet fabrication with a crosslinker.

### BACKGROUND

Binder jetting is an additive manufacturing process with many advantages. It can be used with almost any material, such as ceramics, metals, and polymers. It can produce parts in a wide range of sizes, up to multiple meters. It can also produce parts with almost any geometry. For example, explicit support is not required for overhang structures. Furthermore, the energy consumption, operational cost, and capital cost of binder jetting are low.

A “green part” refers to the state of a part after the initial shaping process but before sintering. A challenging issue in binder jetting is that green parts are usually too weak to directly serve in many applications. Sintering is often performed to strengthen the green parts. However, sintering is not an option with materials that are sensitive to high temperatures, such as sorbents for gas separation (e.g., carbon capture sorbents, etc.).

### SUMMARY

According to some embodiments, a method for binder jetting of a green part comprises preparing a binder, a powder, and a crosslinker for binder jet fabrication, printing the green part layer by layer by cyclically spreading a layer of powder, selectively jetting the binder through a first set of printhead nozzles into the layer of powder, and selectively jetting the crosslinker through a second set of printhead nozzles, curing a job box containing loose powder and the green part comprising the binder, the powder, and the crosslinker, and depowdering the green part by removing the green part from the loose powder.

Particular embodiments may comprise one or more of the following features. The binder may comprise polyethylenimine. The powder may comprise Zeolite 13X. The crosslinker may comprise 1,2,5,6-diepoxyhexane (DEH). The first set of printhead nozzles and the second set of printhead nozzles may be on different printheads. The first set of printhead nozzles and the second set of printhead nozzles may be on one printhead.

According to some embodiments, a method for binder jetting of a green part comprises preparing a binder and a powder for binder jet fabrication, wherein a crosslinker is premixed with one of the binder and the powder, printing the green part layer by layer by cyclically spreading a layer of powder and selectively jetting the binder through a printhead into the layer of powder, curing a job box containing loose powder and the green part comprising the binder, the powder, and the crosslinker, and depowdering the green part by removing the green part from the loose powder.

Particular embodiments may comprise one or more of the following features. The binder may comprise polyethylenimine. The powder may comprise Zeolite 13X. The crosslinker may comprise 1,2,5,6-diepoxyhexane (DEH). The crosslinker may be premixed with the binder. The crosslinker may be premixed with the powder.

According to some embodiments, a method for binder jetting of a green part comprises preparing a binder comprising a first sorbent and a powder comprising a second sorbent for binder jet fabrication, printing the green part layer by layer by cyclically spreading a layer of powder and selectively jetting the binder through a printhead into the layer of powder, curing a job box containing loose powder and the green part comprising the binder, the powder, and a crosslinker, and depowdering the green part by removing the green part from the loose powder.

Particular embodiments may comprise one or more of the following features. The crosslinker may be premixed with one of the binder and the powder. The method may further comprise preparing the crosslinker for jet deposition, wherein printing the green part layer by layer comprises selectively jetting the binder through a first set of printhead nozzles and selectively jetting the crosslinker through a second set of printhead nozzles. The first set of printhead nozzles and the second set of printhead nozzles may be on different printheads. The first set of printhead nozzles and the second set of printhead nozzles may be on one printhead. The binder may comprise polyethylenimine. The powder may comprise Zeolite 13X. The crosslinker may comprise 1,2,5,6-diepoxyhexane (DEH).

According to some embodiments, a composition comprises a binder comprising a first sorbent having functional groups, a powder comprising a second sorbent, and a crosslinker capable of forming covalent bonds with the functional groups of the first sorbent, wherein the binder and the crosslinker are configured to form a chemically bonded network.

Particular embodiments may comprise one or more of the following features. The crosslinker may comprise 1,2,5,6-diepoxyhexane. The powder may comprise a porous material selected from the group consisting of zeolites, silicas, aluminas, activated carbons, and cellulose. The composition may exhibit enhanced carbon dioxide sorption capacity relative to a composition comprising an inert binder. The binder may comprise a polyamine, a polyacrylamide, or a polyvinyl alcohol. The composition may form the chemically bonded network without requiring thermal sintering above 150° C. The binder may comprise polyethylenimine. The powder may comprise Zeolite 13X.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIG. 1A is a schematic illustrating a method of fabricating strong green parts using binder jetting, where a crosslinker and the binder are both jetted via one printhead according to some embodiments.

FIG. 1B is a schematic illustrating a method of fabricating strong green parts using binder jetting, where a crosslinker and the binder are jetted via different printheads according to some embodiments.

FIG. 2 is a schematic illustrating a method of fabricating strong green parts using binder jetting, where a crosslinker is pre-mixed into the binder prior to printing according to some embodiments.

FIG. 3 is a schematic illustrating a method of fabricating strong green parts using binder jetting, where a crosslinker is pre-mixed into the powder prior to printing according to some embodiments.

FIGS. 4A and 4B provide a comparative diagram showing the difference in bonding between conventional processes and the presently disclosed method, with FIG. 4A showing a physically entangled network of PEI molecules in conventional processes and FIG. 4B showing the chemically bonded network formed using the crosslinker.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Contemplated herein is a method for the binder jetting of strong green parts using a crosslinker. A crosslinker is a chemical species that can form covalent bonds between polymer chains, thereby converting a linear or branched polymer system into a networked structure. In the context of binder jetting, a crosslinker can react with functional groups on binder molecules-such as amines, carboxylic acids, or hydroxyls-resulting in a chemically bonded, three-dimensional network. This crosslinking process substantially increases the mechanical integrity of the green part by replacing weak physical entanglements with strong covalent bonds. Depending on the chemistry involved, crosslinkers may include multifunctional epoxies, aldehydes, isocyanates, or other reactive species capable of initiating thermally, catalytically, or through proximity-induced reactions. The deliberate inclusion of a crosslinker into the binder jetting process enables the production of green parts with significantly enhanced strength and stability, especially critical for applications involving materials that cannot undergo high-temperature post-processing.

In some embodiments, the bonds created through the presently disclosed crosslinker will allow binder jetting to produce strong green parts directly, without requiring high-temperature thermal processing. This capability opens up a new class of materials and applications that were not feasible with conventional binder jetting methods, such as allowing for binder jetting with heat-sensitive materials that cannot survive high-temperature thermal processing. According to various embodiments, the crosslinker facilitates the formation of covalent bonds among the binder molecules, resulting in a three-dimensional chemically bonded network in lieu of a physically entangled network. According to various embodiments, strong green parts can be used as sorbents for gas separation (such as carbon capture sorbent materials) and water treatment, catalysts, tooling, and the like.

Like conventional binder jetting itself, the crosslinker-based method contemplated herein opens up a staggering number of new applications for this manufacturing technology. One particular application is the manufacturing of objects out of material that can absorb carbon dioxide, for the purpose of carbon capture.

Based on the U.N. IPCC's latest comprehensive assessment, the deployment of CO2 removal technologies will be necessary to achieve net zero emissions. According to U.N. IPCC's prediction, at least 2 gigatonnes of CO2 must be removed from the atmosphere by 2030. The U.S. government is providing a financial incentive of $130-180 per tonne of CO2 removed through direct air capture (i.e., directly capturing CO2 from the atmosphere). With these values, the market is estimated to be on the scale of ˜$100 billion. Furthermore, the amount of CO2 needing to be removed will significantly increase in the coming decades, meaning this huge market will continue to expand.

The crosslinker-based method contemplated herein holds the potential to significantly improve the performance of these direct air capture products. The economics driving the use of direct air capture leave the devices a very thin energy budget to operate within. The ability to shape sorbent materials into almost any geometry will make it possible to maximize exposure at minimal energy cost. In some cases, these shapes may also accelerate the release of the captured carbon dioxide through exposure to a release medium (e.g., water, steam, heat, electricity, etc.), depending upon the sorbent material.

Of course, sorbent materials are one of many temperature-sensitive materials that can be shaped into strong green parts using the crosslinker-based methods contemplated herein. The improved binder jetting process holds the potential to significantly expand the application space of this already versatile technology.

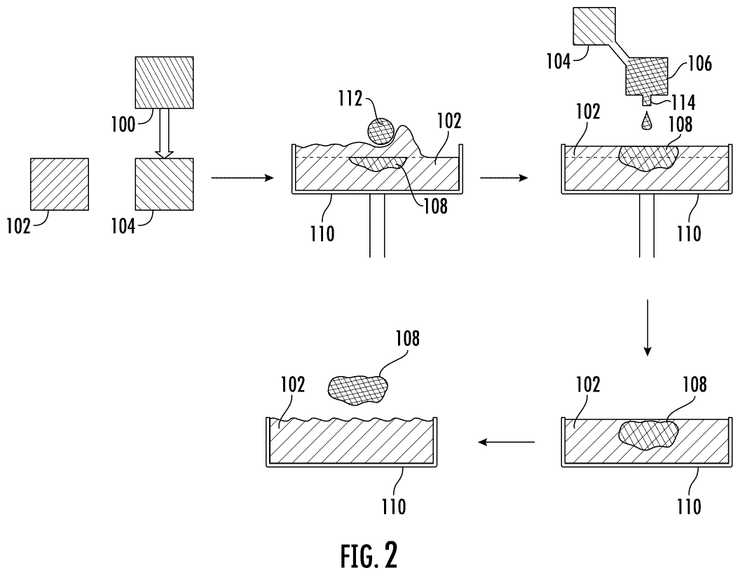

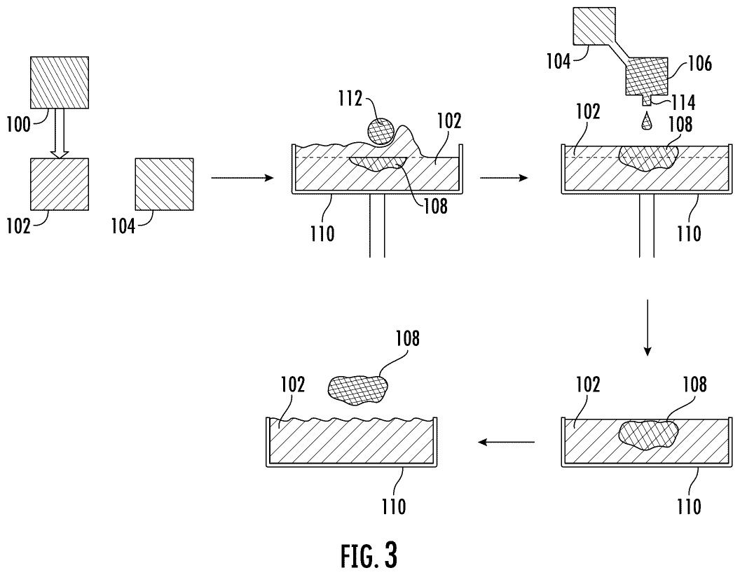

The binder jetting process incorporating a crosslinker 100 may generally be divided into four major stages: (1) material preparation; (2) printing; (3) curing; and (4) depowdering. First, the powder 102 and the binder 104 are prepared. These raw materials are chosen and prepared to have favorable characteristics for the downstream processes and applications. In some embodiments, as part of preparing the binder 104 and the powder 102, the crosslinker 100 is premixed with the binder 104 or powder 102. As illustrated in FIG. 2, in some embodiments, the crosslinker 100 is premixed with the binder 104. As illustrated in FIG. 3, in some embodiments, the crosslinker 100 is premixed with the powder 102. A person of skill in the art will understand that, in some embodiments, the crosslinker 100 may be premixed with both the binder 104 and with the powder 102. While the following discussion is done in the context of an embodiment where the crosslinker 100 is introduced in-situ through a printhead 106, it should be noted that in other embodiments the crosslinker 100 may be mixed with the powder 102, with the binder 104, or both.

In a specific, non-limiting example, the binder 104 is polyethylenimine (PEI), the powder 102 is Zeolite 13X, and the crosslinker 100 is 1,2,5,6-diepoxyhexane (DEH). In preparing the materials, the binder 104 and the crosslinker 100 may be prepared as methanol solutions of polyethylenimine (PEI) and DEH, respectively. Each solution is prepared by mixing PEI or DEH with methanol and stirring for 2 hours. The Zeolite 13X powder 102 is dried in an oven at 150° C. under vacuum for 3 hours before being used for binder jetting.

According to various embodiments, the crosslinker 100 may be prepared as a formulation suitable for jet deposition. In such embodiments, the crosslinker 100 is dissolved or dispersed in a carrier solvent to achieve a viscosity and surface tension compatible with binder jetting equipment. Suitable solvents may include alcohols (e.g., methanol, ethanol), ketones (e.g., acetone), or aqueous mixtures, provided they do not interfere with the chemical reactivity of the binder 104 or the powder 102. The formulation may also include optional additives such as surfactants or rheology modifiers to optimize jetting performance.

It should be noted that the use of a first sorbent (e.g., PEI herein) as a binder 104 and a second sorbent (e.g., zeolite herein) as a powder 102 is a novel combination in binder jetting, even without applying the contemplated method for strengthening green parts. Conventional efforts to shape carbon dioxide sorbents using binder jetting techniques have been limited to compositions where the binder does not sorb CO2. The use of a sorbent as a binder 104 is advantageous because it will sorb carbon dioxide, as does the powder 102. Accordingly, novel sorbent structures may be fabricated through binder jetting by using a first sorbent as the binder 104 and a second sorbent as the powder 102. This approach represents a novel binder-powder pairing in the context of sorbent shaping for gas separation. The use of a sorbent binder 104 in conjunction with a sorbent powder 102 enables printed green parts 108 in which the entire structure contributes to carbon dioxide sorption, potentially increasing uptake capacity, kinetics, or regeneration characteristics compared to conventional sorbent shaping methods where the binder is inert. Some of these printed structures (i.e., green parts 108) may be further strengthened using the methods and crosslinkers 100 contemplated herein.

Next is the printing of the green part 108. According to various embodiments, printing can be done with any binder jetting machine, using the binder 104 and powder 102 described above. The process starts with spreading a uniform layer of powder 102. This may be done by adding powder 102 to the job box 110 and moving a recoater roller or recoater blade 112 across the job box 110 to level the powder 102. The binder 104 is then selectively jetted through a printhead 106 according to the cross-sectional shape of the desired parts. In some embodiments, the crosslinker 100 is also jetted into the powder 102, in situ through a printhead 106. These procedures are repeated layer by layer until the entire parts are built.

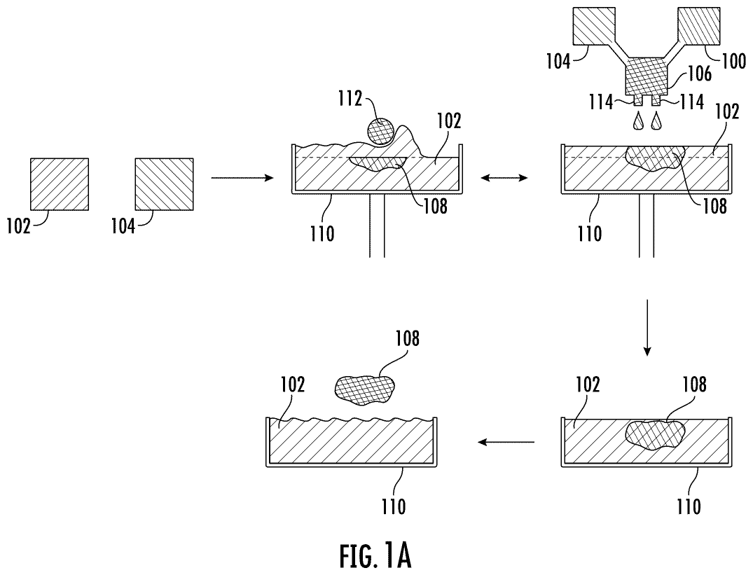

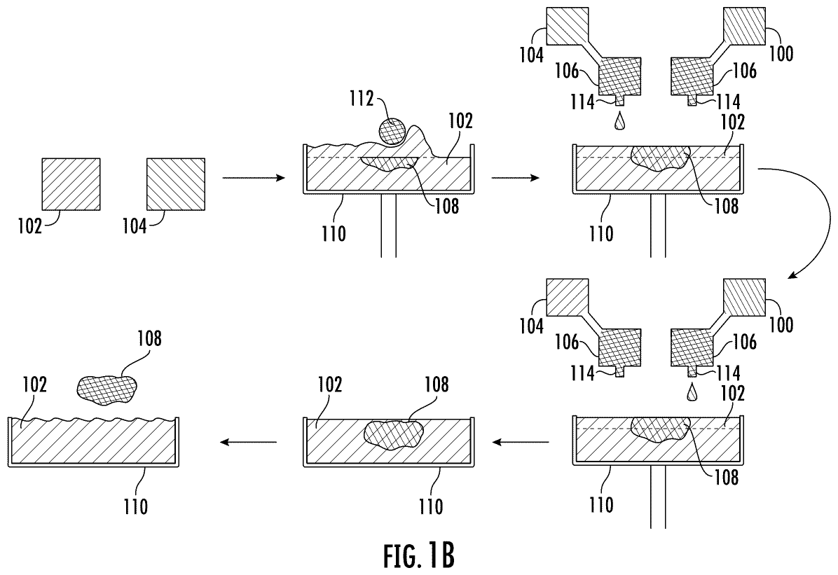

Continuing with the specific example from above, the solution containing the binder 104 and the solution containing the crosslinker 100 can be separately jetted from different nozzles 114 of one printhead 106 to the desired location in the job box 110, as shown in FIG. 1A. Alternatively, in some embodiments, the solution containing the binder 104 and the solution containing the crosslinker 100 can be separately jetted from two different printheads 106 to the desired location in the job box 110. The molar ratio of DEH to PEI can be changed from 0.5, 1, 2, 5, and 10, according to various embodiments.

In some embodiments, the jetting of the binder 104 and the crosslinker 100 may be controlled by adjusting printhead parameters such as drop volume, firing frequency, and nozzle temperature. These parameters may be selected to prevent premature crosslinking, ensure adequate wetting and penetration of the powder 102, and maintain resolution and dimensional fidelity of the printed features. In certain cases, the binder and crosslinker may be sequentially deposited or simultaneously jetted depending on desired crosslinking kinetics and layer integration. The ambient temperature, humidity, and powder bed temperature may also be controlled to promote optimal reaction conditions.

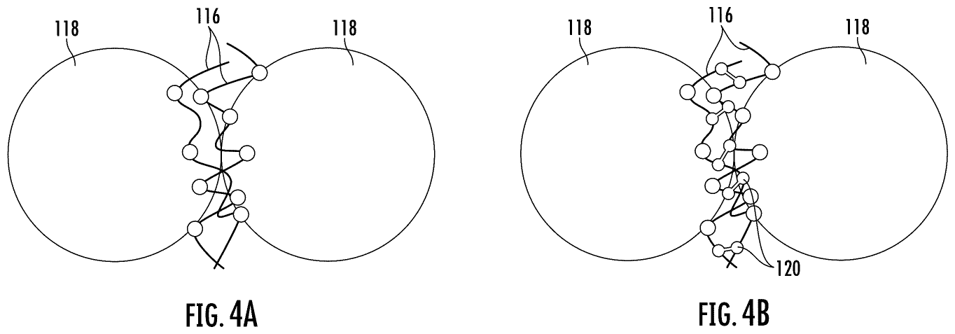

After the printing comes the curing that strengthens the green parts 108. According to various embodiments, the curing step is performed by placing the entire job box 110 containing the printed parts 108 and the loose powder 102 in a vacuum oven for curing. In some embodiments, the curing is performed in an oven at 45° C. for 8 hours to ensure a complete crosslinking reaction, and then at 80° C. under vacuum for 8 hours to fully evaporate the solvent. These green parts 108 have now been strengthened by covalent bonds formed among the binder molecules (FIG. 4B), therefore resulting in a chemically bonded binder network in lieu of a physically entangled network.

The final step, according to various embodiments, is depowdering, where the green parts 108 are retrieved from the surrounding loose powder 102.

In this specific, non-limiting example, the binder 104 was PEI (a polyamine), the powder 102 was Zeolite 13X, and crosslinker 100 was DEH. According to various embodiments, DEH will work with other binders 104 including, but not limited to, other polyamines and other compounds containing amine functional groups. Additionally, other embodiments may comprise any other powder known in the art.

According to various embodiments, other suitable binders 104 may include, but are not limited to, polyamines, polyacrylamides, polyvinyl alcohols, polysaccharides, and other water-soluble or alcohol-soluble polymers that possess reactive functional groups. Other suitable crosslinkers 100 may include, but are not limited to, glutaraldehyde, epichlorohydrin, diisocyanates, or other multifunctional electrophilic compounds capable of forming covalent linkages with the binder. The powder 102 may comprise any particulate material suitable for binder jetting, including, for example, silica, alumina, activated carbon, cellulose, or other inorganic or organic powders having appropriate flow and packing characteristics. The selection of binder 104, powder 102, and crosslinker 100 may be tailored based on the target application, chemical compatibility, and mechanical performance requirements of the green parts 108.

FIGS. 4A and 4B illustrate the difference between the bonds formed in green parts made via conventional binder jetting processes, and the strengthened green parts 108 formed using the crosslinker-based methods contemplated herein. As shown, in the baseline case shown in FIG. 4A, PEI molecules 116 (i.e., the binder 104) form a physically entangled network among the zeolite particles 118 (i.e., the powder 102). This physically entangled network is not as strong as the chemical bonds formed using the crosslinker method contemplated herein. As shown in FIG. 4B, when using the contemplated method, a crosslinker 100 is jetted in addition to the binder 104, enabling PEI molecules 116 to form a chemically bonded network in lieu of a physically entangled network. The chemically bonded network has crosslinks 120 that strengthen the part 108 This ultimately results in stronger green parts 108.

The incorporation of a crosslinker 100 into the binder jetting workflow, as described above, allows for tailoring of bond strength, geometry, and material compatibility. This significantly broadens the range of usable materials and eliminates the need for post-processing sintering in many cases. Functionality of the resulting parts is broadened, including improved mechanical integrity and compatibility with non-sinterable materials, while also reducing processing cost and complexity.

A person of ordinary skill in the art, having the benefit of this disclosure, will recognize that the presently described method can be extended to a wide variety of binder-powder-crosslinker systems. The nature of the binder 104, powder 102, and crosslinker 100 may be selected based on application-specific parameters such as target chemical functionality, porosity, sorption behavior, or mechanical robustness. As such, the presently disclosed systems and methods are adaptable to numerous functional materials and are not limited to the specific combinations described herein.

The present disclosure is related to a composition that may be produced using the method described above, or another method. The composition may comprise the binder 104, the powder 102, and the crosslinker 100. In some embodiments, the binder 104 comprises a first sorbent and the powder 102 comprises a second sorbent. The first sorbent may have functional groups. The crosslinker 100 may be capable of forming covalent bonds with the functional groups of the first sorbent. The binder 104 and the crosslinker 100 may be configured to form a chemically bonded network. As noted above, the crosslinker 100 may comprise 1,2,5,6-diepoxyhexane. The powder 102 may comprise a porous material selected from the group consisting of zeolites, silicas, aluminas, activated carbons, and cellulose. In some embodiments, the composition exhibits enhanced carbon dioxide sorption capacity relative to a composition comprising an inert binder. In some embodiments, the binder 104 comprises a polyamine, a polyacrylamide, or a polyvinyl alcohol. The composition may form the chemically bonded network without requiring thermal sintering above 150° C. As noted above, the binder 104 may comprise polyethylenimine and the powder 102 may comprise Zeolite 13X.

Many additional implementations, variations, and optimizations based on the disclosed principles are possible and will be apparent to one of ordinary skill in the art. Further implementations are within the CLAIMS.

It will be understood that implementations are not limited to the specific components disclosed herein, as virtually any components consistent with the intended operation of a method and/or system implementation for binder jetting of strong green parts using a crosslinker may be utilized. Accordingly, for example, although particular binders, powders, and crosslinkers may be disclosed, such components may comprise any shape, size, style, type, model, version, class, grade, measurement, concentration, material, weight, quantity, and/or the like consistent with the intended operation of a method and/or system implementation for binder jetting of strong green parts using a crosslinker.

In places where the description above refers to particular implementations of binder jetting of strong green parts using a crosslinker, it should be readily apparent that a number of modifications may be made without departing from the spirit thereof and that these implementations may be applied to other additive fabrication processes. The presently disclosed methods and systems are, therefore, to be considered in all respects as illustrative and not restrictive.

I claim:

1. A method for binder jetting of a green part, the method comprising:
preparing a binder, a powder, and a crosslinker for binder jet fabrication;
printing the green part layer by layer by cyclically spreading a layer of powder, selectively jetting the binder through a first set of printhead nozzles into the layer of powder, and selectively jetting the crosslinker through a second set of printhead nozzles;
curing a job box containing loose powder and the green part comprising the binder, the powder, and the crosslinker; and
depowdering the green part by removing the green part from the loose powder.

2. The method of claim 1, wherein the binder comprises polyethylenimine.

3. The method of claim 1, wherein the powder comprises Zeolite 13X.

4. The method of claim 1, wherein the crosslinker comprises 1,2,5,6-diepoxyhexane (DEH).

5. The method of claim 1, wherein the first set of printhead nozzles and the second set of printhead nozzles are on different printheads.

6. The method of claim 1, wherein the first set of printhead nozzles and the second set of printhead nozzles are on one printhead.

7. A method for binder jetting of a green part, the method comprising:
preparing a binder and a powder for binder jet fabrication, wherein a crosslinker is premixed with one of the binder and the powder;
printing the green part layer by layer by cyclically spreading a layer of powder and selectively jetting the binder through a printhead into the layer of powder;
curing a job box containing loose powder and the green part comprising the binder, the powder, and the crosslinker; and
depowdering the green part by removing the green part from the loose powder.

8. The method of claim 7, wherein the binder comprises polyethylenimine.

9. The method of claim 7, wherein the powder comprises Zeolite 13X.

10. The method of claim 7, wherein the crosslinker comprises 1,2,5,6-diepoxyhexane (DEH).

11. The method of claim 7, wherein the crosslinker is premixed with the binder.

12. The method of claim 7, wherein the crosslinker is premixed with the powder.

13. A composition, comprising:
a binder comprising a first sorbent having functional groups;
a powder comprising a second sorbent; and
a crosslinker capable of forming covalent bonds with the functional groups of the first sorbent,
wherein the binder and the crosslinker are configured to form a chemically bonded network.

14. The composition of claim 13, wherein the crosslinker comprises 1,2,5,6-diepoxyhexane.

15. The composition of claim 13, wherein the powder comprises a porous material selected from the group consisting of zeolites, silicas, aluminas, activated carbons, and cellulose.

16. The composition of claim 13, wherein the composition exhibits enhanced carbon dioxide sorption capacity relative to a composition comprising an inert binder.

17. The composition of claim 13, wherein the binder comprises a polyamine, a polyacrylamide, or a polyvinyl alcohol.

18. The composition of claim 13, wherein the composition forms the chemically bonded network without requiring thermal sintering above 150° C.

19. The composition of claim 13, wherein the binder comprises polyethylenimine.

20. The composition of claim 13, wherein the powder comprises Zeolite 13X.
